(19) United States
(12) Patent Application Publication
(10) Pub. No.: US 2003/0147989 A1
(43) Pub. Date: Aug. 7, 2003

(54) Die clamping unit of an injection molding machine

(75) Inventors: Toshihiro Kasai, Mishima-shi (JP); Takaki Miyauchi, Numazu-shi (JP); Makoto Nishizawa, Numazu-shi (JP)

Correspondence Address: PILLSBURY WINTHROP, LLP, P.O. BOX 10500, MCLEAN, VA, 22102, US

(73) Assignee: TOSHIBA MACHINE CO., LTD., Tokyo (JP)

(21) Appl. No.: 10/358,307

(22) Filed: Feb. 5, 2003

(30) Foreign Application Priority Data
Feb. 5, 2002 (JP) 2002-028450

(51) Int. Cl. B29C 45/66

(52) U.S. Cl. 425/593; 425/451.6

(57) ABSTRACT

A stationary platen and link housing are coupled to each other through tie bars. A movable platen is coupled to a front surface of the link housing through a toggle mechanism. Two slide bars are fixed to the back surface of the movable platen and each slide bar extends in a parallel way from a back surface toward the moving direction of the movable platen. Two hollow shafts are each fixed to the front surface of the link housing so as to correspond to the slide bar. Each hollow shaft extends in a parallel way from a front surface toward the moving direction of the movable platen. Each respective slide bar is inserted into the inside of the corresponding hollow shaft to allow it to slide along the inside of the hollow shaft.

### CROSS-REFERENCE TO RELATED APPLICATIONS

This application is based upon and claims the benefit of priority from the prior Japanese Patent Application No. 2002-028450, filed Feb. 5, 2002, the entire contents of which are incorporated herein by reference.

### BACKGROUND OF THE INVENTION

1. Field of the Invention

The present invention relates to a die clamping unit of an injection molding machine and, in particular, to a structure of a guide mechanism for, in a toggle-type die clamping unit, restricting the moving direction of a movable platen to an axial direction of the unit.

2. Description of the Related Art

FIGS. 4A and 4B show structures diagrammatically showing a conventional toggle-type die clamping unit.

A stationary platen 1 and movable platen 2 are arranged opposite each other. A stationary die 3 is attached in front of the stationary platen 1 while a movable die 4 is attached in front of the movable platen 2. A link housing 5 is arranged on the back side of the movable platen 2.

The stationary platen 1 and link housing 5 are connected to each other by four tie bars 6. The tie bars 6 extend through the four near-corner portions of the movable platen respectively. One end of the respective tie bar is fixed to the stationary platen 1 while the other end of the respective tie bar is connected to the link housing 5 via a feed screw mechanism. The respective tie bar 6 has a threaded portion to allow it to pass through the link housing 5. Nuts (not shown in the figure) are rotatably attached to the link housing 5. By driving the respective nut, the link housing 5 is moved forward or backward relative to the stationary platen 1 to adjust a distance therebetween.

A toggle mechanism 7 is supported in front of the link housing 5. The movable platen 2 is coupled to the link housing 5 through the toggle mechanism 7. The toggle mechanism 7 comprises a hydraulic cylinder 19 (a ball screw, etc., in the case of an electrically driving type), a crosshead 13, a toggle link 15, etc. The hydraulic cylinder serves as a drive source. By moving the crosshead 13 forward and backward in the axial direction with the use of the hydraulic cylinder 19, the toggle link 15 extends or contracts. By doing so, the movable platen 2 is moved forward and backward to close and open the dies.

The movable platen 2 is slidably moved along the tie bars 6. At the lower surface of the movable platen 2 a roller-type (or wedge-type) support mechanism, not shown, is mounted to support the platen weight and the die weight.

Upon the clamping of the dies, the dies are closed immediately before the toggle mechanism 7 extends to a full extent. After this, the toggle mechanism 7 further extends to produce a die clamping force. The force exerted by the hydraulic cylinder 19 is increased, by the toggle mechanism 7, several-fold and applied to the dies 3 and 4. At this time, a reaction force corresponding to the die clamping force acts upon the tie bars 6. And the tie bars 6 are elastically deformed and stretched.

(Problem of Conventional Toggle-Type Die Clamping Unit)

In the conventional toggle-type die clamping unit as set out above, the degree of parallelism between the dies, that is, the degree of parallelism between the stationary platen 1 and the movable platen 2, is determined according to whether or not the movable platen 2 sliding on the tie bars 6 can move parallel to the tie bars 6 (mounted perpendicularly relative to the stationary platen 1).

As shown in a partially enlarged view in FIG. 4B, slidable members 41 are provided at those areas of the movable platen where the tie bars 6 pass so that the tie bars can be moved smoothly. In addition, a tiny gap δ is also provided to allow the formation of an oil film. There is a possibility that, at the movable platen 2, a tilt of θ=tan⁻¹(δ/L) will be created by both the gap δ between the slidable member 41 and the tie bars 6 and the support length L over which the tie bar is supported by the slidable member 41. Due to the tilt angle θ, a problem occurs as set out below. That is, between the stationary die 3 attached to the stationary platen 1 and the movable die 4 attached to the movable platen 2, a guide pin was not smoothly inserted or, in a compression molding, it was not possible to obtain a product of uniform thickness by the compression step.

As a method of making the tilt angle θ smaller, it is considered that the support length L be made greater. Since, however, the value of the support length can be made only to about the extent corresponding to the thickness of the movable platen 2, it is not possible to decrease the tilt angle θ to such a small extent. Making the gap smaller is hard to achieve because it is necessary to secure an oil film thickness. It is also hard to achieve because it is necessary to suppress a mounting pitch difference between the four tie bars 6.

As shown in FIG. 4A, a method has thus far been adopted according to which bar-like slide members 21 (hereinafter referred to as slide bars) are projected from behind the movable platen 2 into corresponding guide bushes 22 embedded in the link housing 5.

If this is done, the tilt angle of θ1=tan⁻¹(δ/L1) can be suppressed to a smaller extent because the length L1 from the front surface of the movable platen 2 to the bush 22 is very large compared to the above-mentioned length L. If this method is adopted, the tip end of the slide bar 21 extends backward from behind the link housing 5 and hence the full length of the unit is increased by an extent corresponding to the stroke of the movable platen 2.

In the hydraulic-type toggle mechanism it is to be noted that the hydraulic cylinder 19 is used as a drive source of the toggle mechanism 7 and mounted on the back side of the link housing 5. Even if, therefore, the tip end of the slide bar 21 is projected from behind the link housing 5, no adverse effect is exerted on the full length of the die clamping unit including the hydraulic cylinder 19.

In the case of the electrically-driven-type toggle mechanism, however, a ball screw for example is used as a drive source of the toggle mechanism 7 and no larger projection is present on the back surface side of the link housing 5. Since, however, the slide bar 21 extends through the link housing 5, the full length of the die clamping unit becomes greater, thus presenting a problem.

### BRIEF SUMMARY OF THE INVENTION

The present invention is achieved in view of the above-mentioned problem encountered in the conventional toggle-type die clamping unit and the object of the present invention is to provide a toggle-type die clamping unit which obviates the need for increasing the full length of the unit due to the presence of a guide mechanism for a movable platen.

The die clamping unit of an injection molding machine according to the present invention comprises a stationary platen; a movable platen arranged opposite to the stationary platen; a link housing arranged at the back side of the movable platen; a toggle mechanism coupled between the link housing and the movable platen; slide bar fixed to the movable platen and extending in a parallel way from a back surface toward the moving direction of the movable platen; and guide member fixed to the link housing and extending toward a forward direction of the link housing, the guide member having a guide hole configured to allow the slide bar to slide therein.

According to the die clamping unit of the injection molding machine of the present invention, the guide member configured to guide the slide bar is located between the movable platen and the link housing and it is not necessary to pass the tip end of the slide bar through the link housing and project it behind the back side of the link housing. Thus it is not necessary to increase the full length of the unit.

Further, the distance from the movable platen to the guide member can be made far greater compared to a support length L, in the conventional structure (FIG. 4A), over which support is effected by the slide member. Thus it is possible to suppress the tilt angle of the movable platen to a smaller extent and hence to enhance the degree of parallelism between the stationary die and movable die.

Preferably, the guide member is comprised of a hollow shaft extending in a parallel way from a front surface of the link housing toward the moving direction of the movable platen and the slide bar is inserted into the inside of the hollow shaft to allow the slide bar to slide therein.

By this structure it is possible to achieve a greater length over which the slider bar contacts the hollow shaft. It is, therefore, possible to suppress the tilt angle of the movable platen to a smaller extent and hence enhance the degree of parallelism between the stationary die and the movable die.

By the use of the hollow shaft it is possible to guide a crosshead of the toggle mechanism from a lateral side. That is, the hollow shaft also serves as guide means for allowing the crosshead to be guided therein.

### BRIEF DESCRIPTION OF THE SEVERAL VIEWS OF THE DRAWING

FIG. 1 is a plan view showing one embodiment of a die clamping unit of an injection molding machine according to the present invention;

FIG. 2 is a front view showing the die clamping unit shown in FIG. 1;

FIG. 3 is a partially enlarged sectional view of the die clamping unit shown in FIG. 1;

FIG. 4A is a structural view diagrammatically showing one form of a die clamping unit of a conventional injection molding machine; and

FIG. 4B is a partially enlarged sectional view of the die clamping unit shown in FIG. 4A.

### DETAILED DESCRIPTION OF THE INVENTION

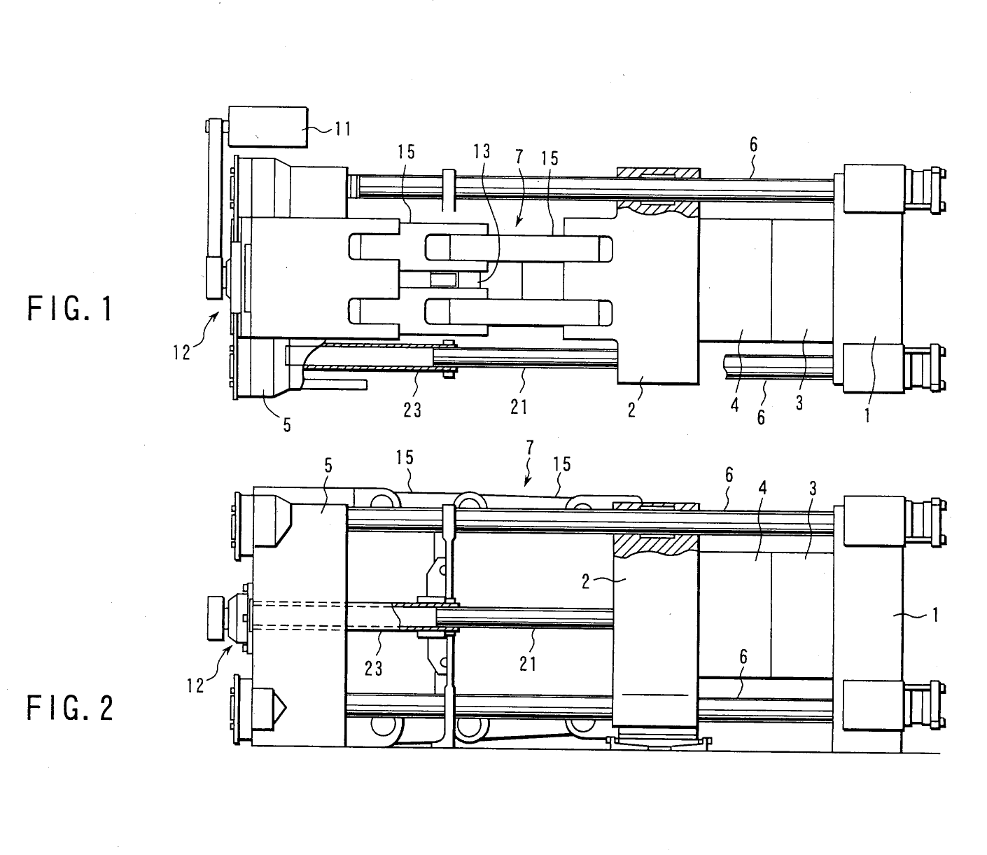

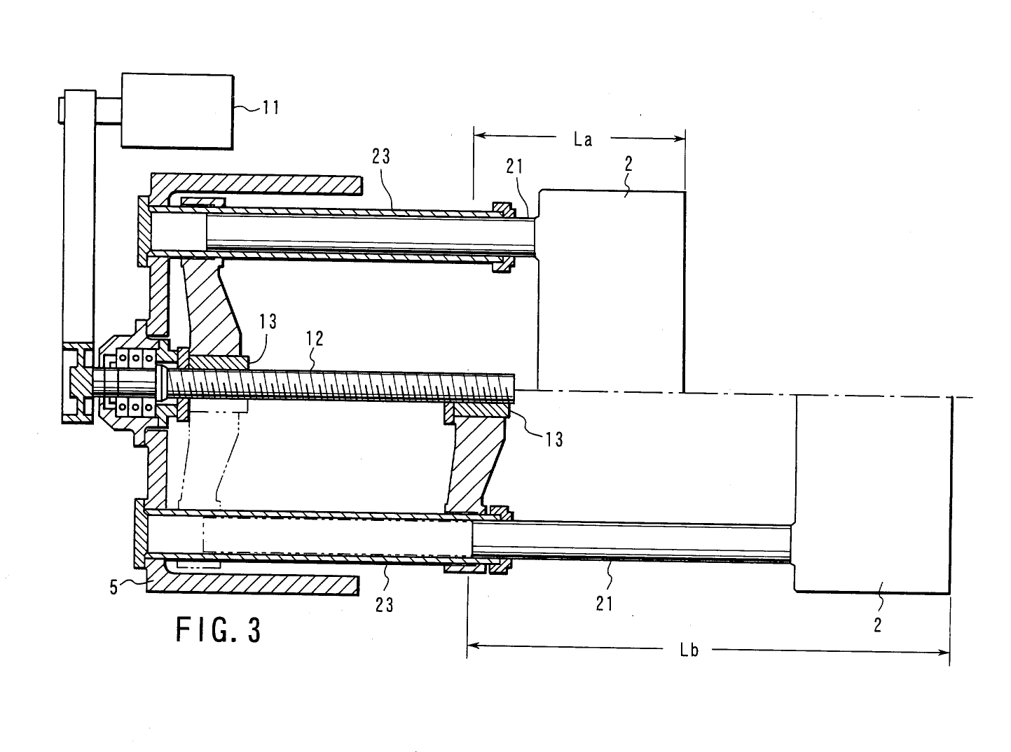

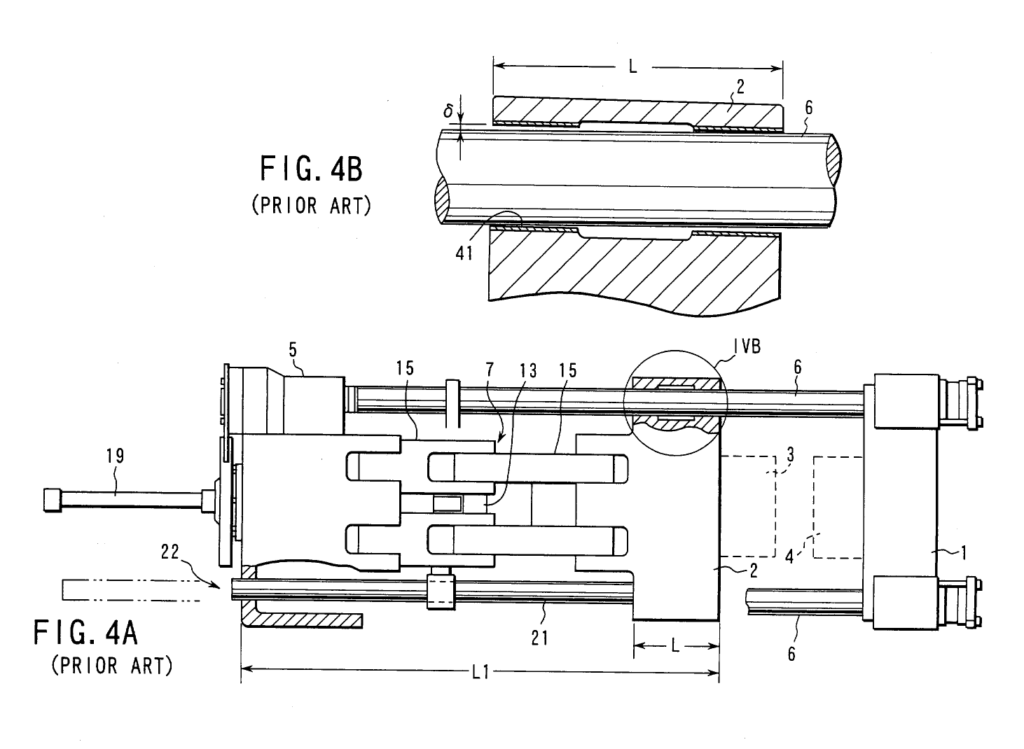

FIGS. 1 to 3 show a diagrammatic structure of a toggle-type die clamping unit of the present invention. It is to be noted that FIG. 1 is a plan view, FIG. 2 is a front view and FIG. 3 is an enlarged sectional view of a guide portion of a movable platen.

A stationary platen 1 and movable platen 2 are arranged opposite each other. A stationary die 3 is attached in front of the stationary platen 1 and a movable die 4 is attached at the front of the movable platen 2. A line housing 5 is arranged at the back of the movable platen 2.

The stationary platen 1 and link housing 5 are coupled to each other through four tie bars 6. The tie bars extend through the near-corner portions of the movable platen 2. One end of each respective tie bar 6 is fixed to the stationary platen 1 while the other end of each respective tie bar extends through the link housing 5 via a feed screw mechanism. By driving each feed screw mechanism, the link housing 5 is moved forward or backward relative to the stationary platen 1 to allow the distance therebetween to be adjusted.

A toggle mechanism 7 is supported at the front surface of the link housing 5 and the movable platen 2 is coupled to the link housing 5 through the toggle mechanism 7.

Further, two slide bars 21 are fixed to the back surface of the movable platen 2. These slide bars 21 extend in a parallel way from the back surface of the movable platen 2 toward the moving direction of the movable platen. Two hollow shafts 23 are fixed to the front surface of the link housing 5 so as to correspond to these two slide bars 21. The hollow shafts 23 extend in a parallel way from the front surface of the link housing 5 toward the moving direction of the movable platen 2. Each respective slide bar 21 is inserted into the corresponding hollow shaft 23 and is slidable inside the hollow shaft 23.

The toggle mechanism 7 comprises a servomotor 11, a ball screw 12 (FIG. 3), a crosshead 13, a toggle link 15, etc. The servomotor serves as a drive source. By moving the crosshead 13 forward or backward in the axial direction through the use of the ball screw 12, the toggle link 15 extends or contracts. Thus, the movable platen 2 is moved forward or backward, thereby closing or opening the dies.

Further, in this embodiment, as shown in FIG. 3, the hollow shafts 23 also serve as guide means for guiding the crosshead 13 of the toggle mechanism 7 from its lateral side.

As shown in FIG. 3, a length La is short in the open state of the dies and the effect of restricting the tilt of the movable platen 2 is smaller. By moving the movable platen 2 forward to a state in which the dies are closed, the support length as indicated by Lb is longer. It is, therefore, possible to make the tilt of the movable platen smaller, that is, to improve the degree of parallelism of the dies.

Further, if the guide mechanism for the movable platen 2 is constructed as set out above, the slide bars 21 can be supported at an intermediate position between the movable platen 2 and the link housing 5 and there is no need to project the tip end of the slide bars 21 beyond the back side of the link housing 5. Therefore, the full length of the unit is not increased.

Although, in the above-mentioned embodiment, the slide bars 21 are supported through the use of the hollow shafts 23, hollow blocks may be used instead of the hollow shafts 23. In this case, each hollow block has a guide through hole, along which the corresponding slide bar 21 is slidable, and is fixed to the link housing 2 in the state that the hollow block projects in front of the link housing 5. In this case, each such block, together with a guide means for guiding the crosshead 13, can be attached to a common support structure.

Although, in the above-mentioned embodiment, an explanation has been made in connection with the electrically-driven-type die clamping unit, the above-mentioned guide mechanism can also be applied to the hydraulic-type die clamping unit.

According to the die clamping unit of an injection molding machine according to the present invention, the full length of the die unit can be made short compared to the case where the slide bars extend through the link housing as in the conventional die clamping unit.

Further, if the guide member for guiding the slide bar is comprised of a hollow shaft, it is possible to achieve a greater length over which the slide bar contacts the hollow shaft. It is, therefore, possible to suppress the tilt angle of the movable platen to a smaller extent and hence to enhance the degree of parallelism between the stationary die and the movable die.

Further, the guide member is comprised of a hollow shaft and, thus, the resultant die clamping unit can be made lighter without a loss of rigidity.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. A die clamping unit of an injection molding machine comprising:
a stationary platen;
a movable platen arranged opposite to the stationary platen;
a link housing arranged at the back side of the movable platen;
a toggle mechanism coupled between the link housing and the movable platen:
a slide bar fixed to the movable platen and extending in a parallel way from a back surface toward a moving direction of the movable platen; and
a guide member fixed to the link housing and projecting toward a forward direction of the link housing, the guide member having a guide hole configured to allow the corresponding slide bar to slide therein.

2. A die clamping unit according to claim 1, in which the guide member is comprised of a hollow shaft extending in a parallel way from a front surface of the link housing toward the moving direction of the movable platen, and the slide bar is inserted into the inside of the hollow shaft to allow the slide bar to slide therein.

3. A die clamping unit according to claim 2, in which the hollow shaft is so configured as to also serve as guide means for allowing a crosshead of the toggle mechanism to be guided from a lateral side.
